(19) United States
(12) Patent Application Publication
(10) Pub. No.: US 2026/0178882 A1
(43) Pub. Date: Jun. 25, 2026

(54) STAGED NEURAL NETWORK CLASSIFICATION

(71) Applicant: AssureCare LLC, Cincinnati, OH (US)

(72) Inventors: Mayur Yermaneni, Austin, TX (US); Abhishek Rao, Cincinnati, OH (US); Josh Shreve, Cincinnati, OH (US); James Burns, Cincinnati, OH (US); Chris Counselman, Cincinnati, OH (US)

(21) Appl. No.: 19/427,696

(22) Filed: Dec. 19, 2025

Related U.S. Application Data
(60) Provisional application No. 63/736,601, filed on Dec. 19, 2024.

(51) Int. Cl. G06N 3/045; G06F 18/2431

(52) U.S. Cl. CPC G06N 3/045; G06F 18/2431

(57) ABSTRACT

Events may be classified in a staged manner using one or more neural networks and explicit classifiers. For example, a method may be performed which comprises classifying an event using a first explicit classifier, a neural network classifier, and a second explicit classifier. In such a method, classifying the event using the first explicit classifier may provide an initial classification for the event, and that initial classification may be a basis for classifying the event using the neural network classifier. Similarly, classifying the event using the neural network classifier may provide a neural network classification for the event, and the event may be classified using the second explicit classifier on the basis of the neural network classification. When the event is processed by the second explicit classifier, this may provide an output classification, and that output classification may be used as a basis for processing the event.

### BACKGROUND

Neural networks have been applied in a plethora of fields, from the convolutional neural networks used in computer vision to the transformers used in text generation. However, the broad applicability and power of neural networks come with significant costs, as current networks can have billions, or even trillions of parameters, each of which must be applied to the network's input in order to determine the appropriate output value(s). Even in contexts where response time is not critical, the intensive processing this requires can raise issues, including, but not limited to, the energy consumption required for network operation. Accordingly, there is a need for improved technology which can address problems currently associated with the deployment and use of neural networks.

### SUMMARY

Described herein are devices, systems and methods for staged classification processing using one or more neural networks and explicit classifiers.

An illustrative implementation of such technology relates to a method comprising classifying an event using a first explicit classifier, a neural network classifier, and a second explicit classifier. In such a method, classifying the event using the first explicit classifier may provide an initial classification for the event, and that initial classification may be a basis for classifying the event using the neural network classifier. Similarly, classifying the event using the neural network classifier may provide a neural network classification for the event, and the event may be classified using the second explicit classifier on the basis of the neural network classification. When the event is processed by the second explicit classifier, this may provide an output classification, and that output classification may be used as a basis for processing the event. Corresponding systems and computer readable media may also be implemented based on this disclosure.

While multiple examples are described herein, still other examples of the described subject matter will become apparent to those skilled in the art from the following detailed description and drawings, which show and describe illustrative examples of disclosed subject matter. As will be realized, the disclosed subject matter is capable of modifications in various aspects, all without departing from the spirit and scope of the described subject matter. Accordingly, the drawings and detailed description are to be regarded as illustrative in nature and not restrictive.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 illustrates an exemplary neural network classifier.

FIG. 2 depicts a data flow diagram for staged classification using a neural network classifier and first and second explicit classifiers.

FIG. 3 depicts a process for staged classification using a neural network classifier and first and second explicit classifiers.

FIG. 4 depicts acts which may be performed after an event is classified using a first explicit classifier in some embodiments.

FIG. 5 depicts acts that may be performed in processing an event based on an output classification from a second explicit classifier.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to apparatus, systems, compositions, and methods for staged applications of neural networks which leverage other types of classification tools. In one embodiment, the disclosed technology is applied to computer security, and particularly to the classification of network communication sources. However, the disclosed technology can also be applied in other contexts, and so the examples provided in the context of computer security or in other contexts should not be treated as implying limitations on the scope of protection provided by this document or any other document claiming the benefit of this disclosure.

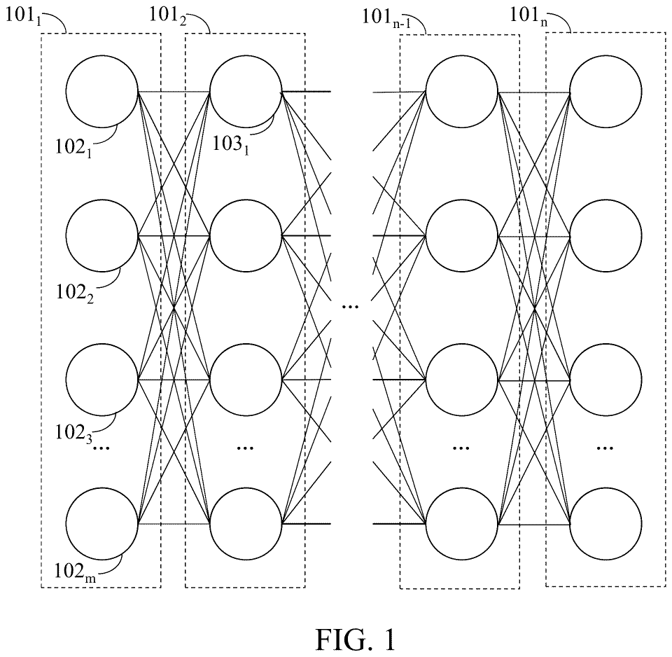

In this disclosure, a neural network should be understood as a type of machine learning model which encodes information in the form of trained parameter values. A neural network classifier should be understood as a neural network in which there is a set of output nodes which each correspond to a category. A graphical representation of an example of such a classifier is shown in FIG. 1. In that figure, a neural network is depicted as comprising n layers, labeled 101₁, 101₂, 101ₙ₋₁, and 101ₙ, with the gap between layers 101₂ and 101ₙ₋₁ representing the potential for additional layers beyond those depicted in FIG. 1.

In the network of FIG. 1, each of the layers comprises a plurality of nodes (e.g., nodes 102₁, 102₂, 102₃ to 102ₘ), each of which has a value. For the first layer 101₁, the value of each node would be an input to the neural network. For example, in a case where the disclosed technology was applied in the field of computer security to evaluate the safety of an entity trying to connect to a network, the value of a first input node 102₁ may be a time at which a connection request was received at a particular address, measured as an offset relative to a first time a connection request was received at any address on the network from the source of the connection request. The values of nodes in subsequent layers could then be derived from the values of nodes in the input layer (or of nodes in other layers between those subsequent layers and the input layer). For example, as shown by the connections between nodes in FIG. 1, the values of the nodes in the input layer 101₁ could feed into the values of nodes in the first hidden layer 101₂. Thus, the value of a first node 103₁ in the first hidden layer 101₂ could be determined by an equation such as equation 1, below:

$$V ( {103}_{1} ) = S ( b + {\sum }_{i = 0}^{m} V ( {102}_{i} ) * W ( {102}_{i} , {103}_{1} ) ) \qquad Equation 1$$

In that equation V(x) is a function which returns the value of node x, so V(103₁) would be the value of node 103₁. S(x) is an activation function which returns the value (1/1+e^{-x}). b is a bias parameter. m is the maximum index of the nodes whose values are used to calculate the value on the left side of the equals sign. W(x, y) is a weight value for the connection between nodes x and y. Similar calculations can be performed for each of the nodes in the network (other than the nodes whose values are provided by an external input), and the network can provide a classification by treating each of the nodes in the final layer 101n as corresponding to a class, and the final layer node with the highest value indicating the class for an event which corresponded to the input (e.g., an entity trying to connect to a network).

To allow a network such as shown in FIG. 1 to effectively classify events, the weight values of connections between nodes (represented by W(x, y) in equation 1) can be defined by requesting that the network classify past events, comparing the network's classification to known correct classifications for those events (referred to as the “ground truth”), and using back propagation to update the values of the weights and the bias parameter when the classification provided by the network for an event differed from the ground truth classification for that event. This past event classification followed by back propagation in the event of an error can be repeated until some stopping condition is satisfied (e.g., the network is able to classify events with some level of accuracy, the improvement provided by further updates reaches a plateau, etc.). At this point, the network may be treated as having been trained, and can be deployed to provide classifications for events whose correct classifications are not yet known.

It should be understood that, while FIG. 1 illustrated an exemplary neural network, variations on the example of FIG. 1 are possible, and could be implemented without undue experimentation by those of skill in the art in light of this disclosure. For instance, while FIG. 1 illustrated an architecture in which the network was made up of multiple dense layers (i.e., layers in which each node was connected to each node in the preceding layer), it is possible that other network structures, such as those found in convolutional networks, transformers, or recurrent neural networks, may also be used. Variations are also possible in calculations used to determine the values of nodes in the network. For example, in some cases, instead of using the sigmoid function 1/(1+e^{-x}) as the activation function, other types of activation functions, such as hyperbolic tangent functions, ReLU (rectified linear unit) functions, or linear activation functions could also be used. Variations are also possible in numbers of layers, and numbers of nodes within layers. For example, in some cases, a model may be made up of four dense layers, in which the output layer has only two nodes (e.g., approve and deny). In other cases, a model may have more layers (e.g., five, ten or more layers) and there may be more than two nodes in the output layer (e.g., approve, deny, approve with respect to certain system resources, etc.). Accordingly, the discussion of exemplary neural networks and variations provided above should be understood as being illustrative only, and should not be treated as implying limitations on the scope of protection provided by this or any related document.

In addition to neural networks, implementations of the disclosed technology may include one or more explicit classifiers. In this context, an explicit classifier should be understood as a module which categorizes an event based on semantically explicit determinations, rather than using the combinations of trained parameter values of a neural network, which often result in that type of model functioning essentially as a black box. Examples of explicit classifiers include binary filters (e.g., the source of a network communication on a known blacklist, does a network communication include a signature of a known virus, etc.), and balancing classifiers (e.g., given the nature of access being requested and the context of the request, does the risk of wrongfully allowing access outweigh the risk of wrongfully denying access). As described in more detail herein, explicit classifiers can be combined with neural networks to provide more robust and efficient classifications than would be possible by applying only a single classification approach.

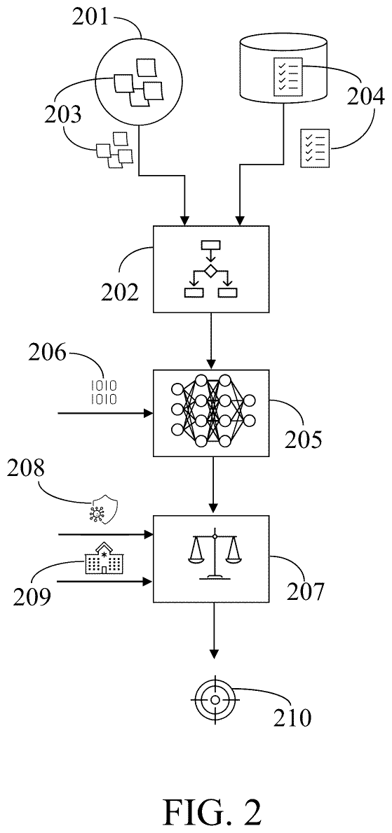

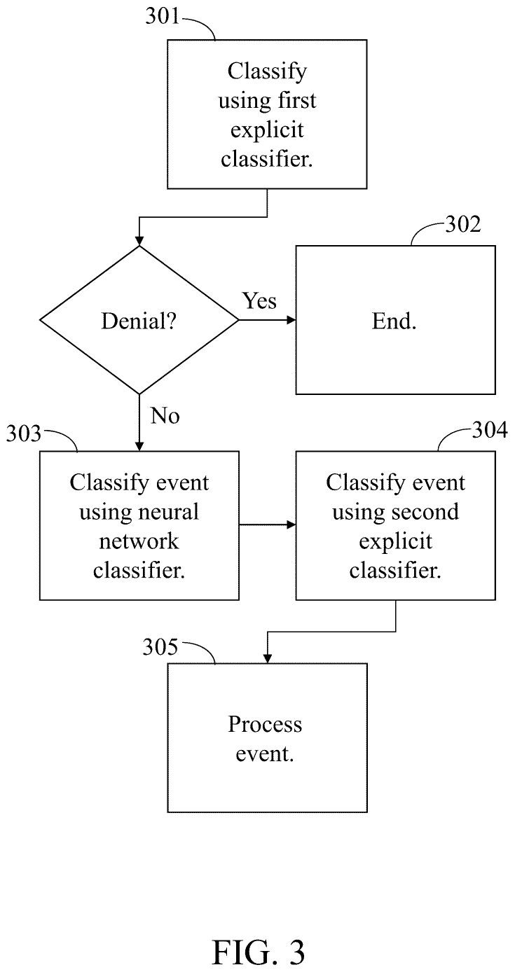

Turning now to FIGS. 2-3, those figures provide a data flow diagram (FIG. 2) and corresponding process (FIG. 3) which can provide classifications using a compound approach with explicit classifiers and a neural network. As shown, a classification task can begin by classifying 301 an event 201 using a first explicit classifier 202. An exemplary approach to implementing this classification could be to provide data 203 related to the event, along with a set of conditions 204 for that data to a first explicit classifier 202 which would use the data 203 and conditions 204 to classify the event using a set of one or more binary filters. For instance, in a case where the disclosed technology was used in computer security to classify requests for access to network resources as requests to be approved or denied, the data 203 related to the event may include the source of request (e.g., an internet protocol address) and/or the payload of the request message, and the conditions 204 may be a blacklist of prohibited sources (e.g., IP addresses for devices known to be included in an active botnet) and a list of known malware signatures. The first explicit classifier 202 may then compare the source of the request with the blacklist and, if there was a match, classify the event (i.e., the request for access to network resources) as one that should be denied. Alternatively, if there was not a match on the blacklist, the first explicit classifier 202 could continue by comparing the request payload against the list of malware signatures. If the comparison identified that the payload matched one or more malware signatures, then the first explicit classifier 202 could classify the event as a request that should be denied. Alternatively, if none of the filtering conditions indicated that the event should be classified as one to be denied, the process of FIG. 3 could continue with further classification steps.

After the event had been classified 301 using the first explicit classifier 202, if an initial classification provided by the first explicit classifier 202 did not indicate that the classification process should terminate 302 (in the process of FIG. 3, if the first explicit classifier 202 did not classify the event as a request that should be denied), then the event could be classified 303 based on the initial classification using a neural network classifier 205. For this classification 303, the neural network classifier 205 could be provided with additional information 206 for the event 201 by mapping that aspects of that information 206 onto nodes in the neural network's input layer as described previously in the context of FIG. 1.

In the process of FIG. 3, once the neural network classifier 205 had provided a neural network classification, that classification may serve as a basis for classifying 304 the event using a second explicit classifier 207. This may be done by using a balancing classifier to derive an output classification using cost 208 and attribute information 209 associated with the classification from the neural network classifier 205. To illustrate how this may take place, consider an example where the neural network classifier 205 had classified a request for access to network resources as a request that should be approved. In this case, the attribute information 209 may be attributes of the network resource to which access was requested, expressed as numerical risk evaluations (e.g., if the network resource was a database storing anonymized data then a data type attribute could have a low risk evaluation, if the network resource was a database storing personal information then the data type attribute could have a medium risk evaluation, and if the network resource was a database storing sensitive personal information then the data type attribute could have a high risk evaluation). The cost information 208 may be a baseline risk level associated with the type of access requested (e.g., a request for read only access may have a first baseline risk level, a request for read/write access may have a second baseline risk level, etc.). These types of information may be combined with each other (e.g., the attribute risk evaluations could be added to, or multiplied with, the baseline risk level) to generate a risk score for the request. The request risk score could then be compared with a predefined risk tolerance threshold to provide an output classification 210 for the event, and the event may be processed 305 (e.g., access to a requested network resource may be provided or refused) based on that output classification 210.

While FIGS. 2-3 and the associated discussion have explained how the disclosed technology can be implemented and used, it should be understood that that discussion is illustrative only, and is not intended to be limiting. For example, while the above discussion explained how the disclosed technology can be used to provide improvements in the field of computer security, it is not limited to being used in that field, and can be applied in other context as well. To illustrate, consider the context of insurance claims processing. The disclosed approaches can be analogously applied to improve insurance claims processing, such as by modifying the classification 301 by the first explicit classifier to classify a claim as one that should be denied if the subject of the claim was not actually insured (instead of classifying an access request as one that should be denied if the requestor was on a blacklist) or if the requested treatment was not actually covered (instead of classifying an access request as one that should be denied if the request payload included a known malware signature). Use in other contexts can also be supported by using data relevant to those contexts in the various classification stages (e.g., performing the classification 301 using the first explicit classifier 202 by comparing an experimental compound against a list of known patented compounds when applying the disclosed technology in the context of drug discovery). Accordingly, the above discussion of potential implementations in the context of computer security should not be treated as implying that the disclosed technology is limited to only being embodied in that field.

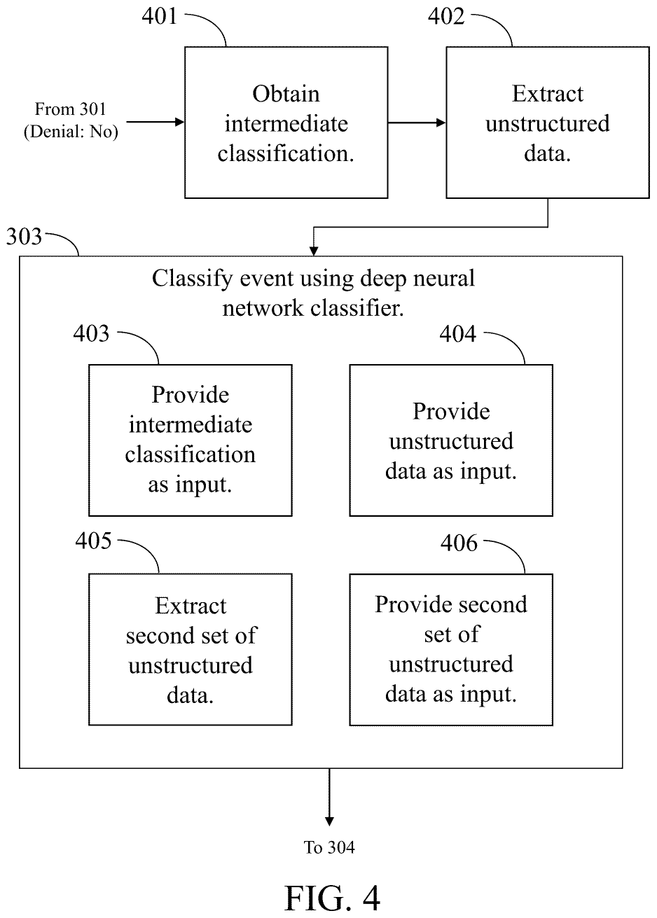

Variations are also possible in aspects other than the context in which an embodiment may be used. For instance, in some cases, an embodiment of the disclosed technology may incorporate acts beyond those illustrated and described above in the context of FIGS. 2-3 and/or may perform acts discussed in the context of FIGS. 2-3 in manners other than laid out in that discussion. To illustrate, consider FIG. 4, which depicts obtaining 401 an intermediate classification for the event as taking place between classifying 301 the event with the first explicit classifier and classifying 303 the event with the neural network classifier. This may be done, for example, by applying a different neural network or explicit classifier to the event, but other approaches are also possible. To illustrate, consider an application of the disclosed technology in the context of claim evaluation. After a first explicit classifier has determined that a claim should not be classified as one that should be denied (e.g., determined that the claimant is eligible and that the relevant policy could cover the request in question) a medical necessity review may be initiated. This review could include an expert or expert system (e.g., a registered nurse or trained large language model) reviewing the insurance claim as well as the patient's medical record and any relevant evidence based guidelines, and providing a note summarizing the results of that review as well as an intermediate classification of whether the claim should be approved or denied. In this context, if the intermediate classification is that the claim should be approved, then it may simply be approved and processed based on the intermediate classification. Alternatively, if the claim is classified as one that should be denied, then the classification process may continue in order to provide additional safeguards against improper denials.

In a method such as shown in FIG. 4, classification following obtaining 401 the intermediate classification for the event may include extracting 402 a set of unstructured data items from a record related to the event. This record may be, for example, a factual summary created in connection with the intermediate classification (e.g., the note summarizing the results of a medical necessity review), and extracting the set of unstructured data items may be done by using an additional neural network (e.g., a recurrent neural network or transformer) trained to identify sentiments and derive confidence values from the factual summary. Then, as part of classifying 303 the event using the neural network classifier, the intermediate classification and associated set of unstructured data items may both be provided 403 404 to the neural network as input (e.g., the neural network classifier may have an input node for the intermediate classification's confidence, as well as input nodes for each of the sentiments an additional neural had been trained to recognize). Other data may also be provided to the neural network classifier as part of this process. For example, in some cases, medical records for the insured (which may be the same medical records as those underlying the intermediate classification) may be analyzed to extract 405 a second set of unstructured data items (e.g., patient morbidities, such as hypertension, diabetes, etc.), such as by using a transformer or recurrent neural network trained to classify medical records as associated with particular topics which would be found in the unstructured data (e.g., whether the patient associated with the record has various morbidities). The presence of these topics for the patient as indicated in the medical record, along with structured data (e.g., patient demographics) which may also have been extracted, can then be provided 406 to the neural network classifier as well. In this way, the neural network classifier may be provided with a broad scope of relevant information, as well as acting as a failsafe to reduce the risk of inappropriate denials.

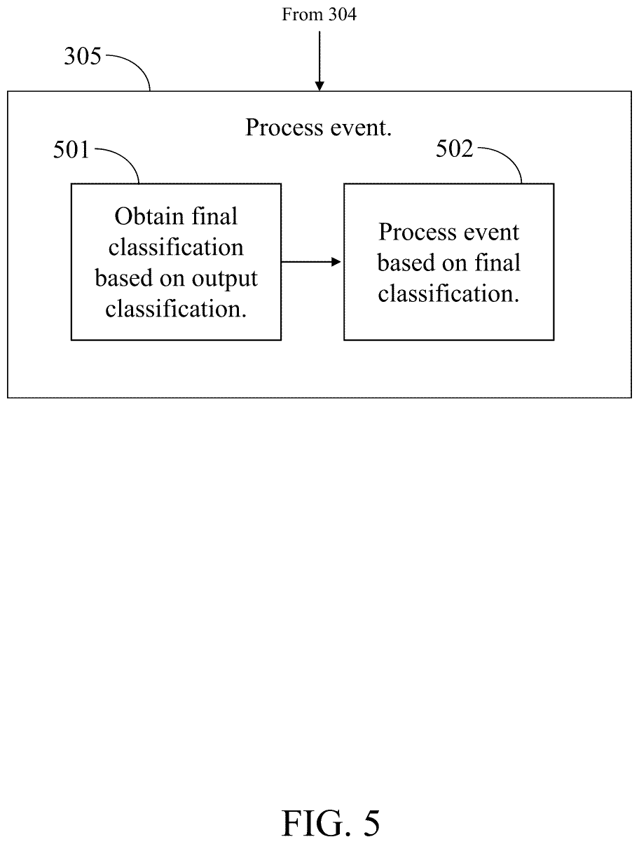

Another example of how implementations of the disclosed technology may vary and/or expand on the discussion of FIGS. 2-3 is provided in FIG. 5, which depicts acts that may be performed in processing 305 an event based on an output classification from a second explicit classifier. Specifically, as shown in FIG. 5, processing 305 the event based on the output classification may include obtaining 501 a final classification for the event based on the output classification, and then processing 502 the event based on the final classification. To illustrate what these acts 501 502 may entail, consider again the potential for the disclosed technology to be used in the context of insurance claims processing. In this context, in the event that the output classification from the second explicit classifier is that the claim being evaluated should be denied, one the basis of that denial, the claim may be routed to a doctor for a final review. The physician could then review the claim and other relevant information (e.g., a patient medical file) and provide the final classification for the event. Then, once that final classification had been obtained 501 by a system implementing the disclosed technology (e.g., an insurance company server) it could control subsequent processing of claim by either initiating the denial process (e.g., generating and sending a letter explaining the reasons for the denial and how to appeal) or the approval process (e.g., by issuing a payment based on the claim) for the claim. Other actions which may be performed in processing 502 a claim based on a final classification may also be performed, both in the insurance context (e.g., offering a partial payment rather than completely approving or denying a claim) and in other contexts (e.g., in the context of computer security, adding an entity which had requested access to a network resource to either a blacklist or a whitelist). Accordingly, the above description of acts which may be performed in the context of processing 305 an event based on an output classification should be understood as being illustrative only, and should not be treated as limiting.

Other variations are also possible, and could be implemented without undue experimentation by those of skill in the art based on this disclosure. For example, while in some cases all data used to classify an event may be provided to/maintained by a first explicit classifier, it is also possible that other approaches may be used in some implementation. For instance, it is also possible that, rather than being provided with conditions 204 to be matched against data 203 related to an event, a first explicit classifier may be part of a software module which is configured to receive the data 203 related to the event, and then use it to interact with an external system to determine if it matched the conditions (e.g., querying a database using the source of an event to determine if the source of the event was already on a blacklist, rather than the first explicit classifier maintaining a copy of the blacklist itself). Another example of a type of variation which may be used in some cases is in the implementation of the second explicit classifier. Specifically, while some implementations may utilize cost 208 and attribute 209 information by treating attributes as modifiers for a baseline cost, this information may also be used in some other ways. For example, in the insurance context, provider attributes (e.g., specialty, previously denied claims) may be used to make choices at decision nodes in a decision tree, with the leaf nodes in the tree corresponding to different cost thresholds that, once selected, could be compared with the cost information 208 for the claim. Variations may also exist in the types of classifications made by one or more of the classifiers used in some embodiments. For example, while it is possible that all classifiers may classify an event into the same classes (e.g., approve or deny), it is also possible that different classifiers may classify an event into different classes. For example, a first explicit classifier may classify an event as a request that should be denied or as a request that should be subject to further processing, while a second explicit classifier may classify an event as a request that should be denied or an event that should be approved. Classifiers may also differ in the number of classifications they may apply to an event. For example, a neural network classifier may classify an event as a request that should be approved, a request that should be denied, or a request that should be subjected to further processing (e.g., if the neural network classifier was not able to classify the event as a request to be approved or denied with sufficient confidence).

As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method comprising: a) classifying an event using a first explicit classifier, wherein classifying the event using the first explicit classifier provides an initial classification for the event; b) based on the initial classification for the event, classifying the event using a neural network classifier, wherein classifying the event using the neural network classifier provides a neural network classification for the event; c) based on the neural network classification for the event, classifying the event using a second explicit classifier, wherein classifying the event using the second explicit classifier provides an output classification for the event; and d) processing the event based on the output classification for the event.

### Example 2

The method of example 1, wherein: a) the method further comprises extracting a set of unstructured data items from a record related to the event; and b) classifying the event using the neural network classifier comprises providing the set of unstructured data items to the neural network classifier as input.

### Example 3

The method of example 2, wherein: a) the method further comprises, based on the initial classification for the event, obtaining an intermediate classification for the event; and b) classifying the event using the neural network classifier comprises providing the intermediate classification for the event to the neural network as input.

### Example 4

The method of example 3, wherein: a) the record relating to the event comprises a factual summary created in connection with the intermediate classification for the event; and b) extracting the set of unstructured data items from the record relating to the event is performed using a neural network other than the neural network classifier.

### Example 5

The method of any of examples 3-4, wherein: a) the method further comprises extracting a second set of unstructured data items from a second record related to the event; and b) classifying the event using the neural network classifier comprises providing the second set of unstructured data items to the neural network as input.

### Example 6

The method of example 5, wherein the second record related to the event is used as a basis for the intermediate classification for the event and for the record related to the event from which the set of unstructured data items are extracted.

### Example 7

The method of any of examples 1-6, wherein processing the event based on the output classification for the event comprises: a) obtaining a final classification for the event based on the output classification for the event; and b) processing the event based on the final classification for the event.

### Example 8

A system comprising: a) a first explicit classifier; b) a neural network classifier; c) a second explicit classifier; d) a processor; and e) a non-transitory computer readable medium storing instructions to perform a method, the method comprising: i) classifying an event using the first explicit classifier, wherein classifying the event using the first explicit classifier provides an initial classification for the event; ii) based on the initial classification for the event, classifying the event using the neural network classifier, wherein classifying the event using the neural network classifier provides a neural network classification for the event; iii) based on the neural network classification for the event, classifying the event using the second explicit classifier, wherein classifying the event using the second explicit classifier provides an output classification for the event; and iv) processing the event based on the output classification for the event.

### Example 9

The system of example 8, wherein: a) the method further comprises extracting a set of unstructured data items from a record related to the event; and b) classifying the event using the neural network classifier comprises providing the set of unstructured data items to the neural network classifier as input.

### Example 10

The system of example 9, wherein: a) the method further comprises, based on the initial classification for the event, obtaining an intermediate classification for the event; and b) classifying the event using the neural network classifier comprises providing the intermediate classification for the event to the neural network as input.

### Example 11

The system of example 10, wherein: a) the record relating to the event comprises a factual summary created in connection with the intermediate classification for the event; and b) the instructions are operable to, when executed, extract the set of unstructured data items from the record relating to the event using a neural network other than the neural network classifier.

### Example 12

The system of any of examples 10-11, wherein: a) the method further comprises extracting a second set of unstructured data items from a second record related to the event; and b) classifying the event using the neural network classifier comprises providing the second set of unstructured data items to the neural network as input.

### Example 13

The system of example 12, wherein the instructions are operable to, when executed, make the second record related to the event available a basis for the intermediate classification for the event and for the record related to the event from which the set of unstructured data items are extracted.

### Example 14

The system of any of examples 8-13, wherein processing the event based on the output classification for the event comprises: a) obtaining a final classification for the event based on the output classification for the event; and b) processing the event based on the final classification for the event.

### Example 15

A non-transitory computer readable medium having stored thereon instructions to perform a method, the method comprising: a) classifying an event using a first explicit classifier, wherein classifying the event using the first explicit classifier provides an initial classification for the event; b) based on the initial classification for the event, classifying the event using a neural network classifier, wherein classifying the event using the neural network classifier provides a neural network classification for the event; c) based on the neural network classification for the event, classifying the event using a second explicit classifier, wherein classifying the event using the second explicit classifier provides an output classification for the event; and d) processing the event based on the output classification for the event.

### Example 16

The computer readable medium of example 15, wherein: a) the method further comprises extracting a set of unstructured data items from a record related to the event; and b) classifying the event using the neural network classifier comprises providing the set of unstructured data items to the neural network classifier as input.

### Example 17

The computer readable medium of example 16, wherein: a) the method further comprises, based on the initial classification for the event, obtaining an intermediate classification for the event; and b) classifying the event using the neural network classifier comprises providing the intermediate classification for the event to the neural network as input.

### Example 18

The computer readable medium of example 17, wherein: a) the record relating to the event comprises a factual summary created in connection with the intermediate classification for the event; and b) the instructions are operable to, when executed, extract the set of unstructured data items from the record relating to the event using a neural network other than the neural network classifier.

### Example 19

The computer readable medium of any of examples 17-18, wherein: a) the method further comprises extracting a second set of unstructured data items from a second record related to the event; and b) classifying the event using the neural network classifier comprises providing the second set of unstructured data items to the neural network as input.

### Example 20

The computer readable medium of example 19, wherein the instructions are operable to, when executed, make the second record related to the event available a basis for the intermediate classification for the event and for the record related to the event from which the set of unstructured data items are extracted.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general purpose dictionary, except that when a term or phrase is indicated as having a particular meaning under the heading Explicit Definitions, it should be understood as having that meaning when used in the claims.

### Explicit Definitions

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and claims, the term “set” should be understood as one or more things which are grouped together.

What is claimed is:

1. A method comprising:
a) classifying an event using a first explicit classifier, wherein classifying the event using the first explicit classifier provides an initial classification for the event;
b) based on the initial classification for the event, classifying the event using a neural network classifier, wherein classifying the event using the neural network classifier provides a neural network classification for the event;
c) based on the neural network classification for the event, classifying the event using a second explicit classifier, wherein classifying the event using the second explicit classifier provides an output classification for the event; and
d) processing the event based on the output classification for the event.

2. The method of claim 1, wherein:
a) the method further comprises extracting a set of unstructured data items from a record related to the event; and
b) classifying the event using the neural network classifier comprises providing the set of unstructured data items to the neural network classifier as input.

3. The method of claim 2, wherein:
a) the method further comprises, based on the initial classification for the event, obtaining an intermediate classification for the event; and
b) classifying the event using the neural network classifier comprises providing the intermediate classification for the event to the neural network as input.

4. The method of claim 3, wherein:
a) the record relating to the event comprises a factual summary created in connection with the intermediate classification for the event; and
b) extracting the set of unstructured data items from the record relating to the event is performed using a neural network other than the neural network classifier.

5. The method of claim 3, wherein:
a) the method further comprises extracting a second set of unstructured data items from a second record related to the event; and
b) classifying the event using the neural network classifier comprises providing the second set of unstructured data items to the neural network as input.

6. The method of claim 5, wherein the second record related to the event is used as a basis for the intermediate classification for the event and for the record related to the event from which the set of unstructured data items are extracted.

7. The method of claim 1, wherein processing the event based on the output classification for the event comprises:
a) obtaining a final classification for the event based on the output classification for the event; and
b) processing the event based on the final classification for the event.

8. A system comprising:
a) a first explicit classifier;
b) a neural network classifier;
c) a second explicit classifier;
d) a processor; and
e) a non-transitory computer readable medium storing instructions to perform a method, the method comprising:
i) classifying an event using the first explicit classifier, wherein classifying the event using the first explicit classifier provides an initial classification for the event;
ii) based on the initial classification for the event, classifying the event using the neural network classifier, wherein classifying the event using the neural network classifier provides a neural network classification for the event;
iii) based on the neural network classification for the event, classifying the event using the second explicit classifier, wherein classifying the event using the second explicit classifier provides an output classification for the event; and
iv) processing the event based on the output classification for the event.

9. The system of claim 8, wherein:
a) the method further comprises extracting a set of unstructured data items from a record related to the event; and
b) classifying the event using the neural network classifier comprises providing the set of unstructured data items to the neural network classifier as input.

10. The system of claim 9, wherein:
a) the method further comprises, based on the initial classification for the event, obtaining an intermediate classification for the event; and
b) classifying the event using the neural network classifier comprises providing the intermediate classification for the event to the neural network as input.

11. The system of claim 10, wherein:
a) the record relating to the event comprises a factual summary created in connection with the intermediate classification for the event; and
b) the instructions are operable to, when executed, extract the set of unstructured data items from the record relating to the event using a neural network other than the neural network classifier.

12. The system of claim 10, wherein:
a) the method further comprises extracting a second set of unstructured data items from a second record related to the event; and
b) classifying the event using the neural network classifier comprises providing the second set of unstructured data items to the neural network as input.

13. The system of claim 12, wherein the instructions are operable to, when executed, make the second record related to the event available a basis for the intermediate classification for the event and for the record related to the event from which the set of unstructured data items are extracted.

14. The system of claim 8, wherein processing the event based on the output classification for the event comprises:
a) obtaining a final classification for the event based on the output classification for the event; and
b) processing the event based on the final classification for the event.

15. A non-transitory computer readable medium having stored thereon instructions to perform a method, the method comprising:
a) classifying an event using a first explicit classifier, wherein classifying the event using the first explicit classifier provides an initial classification for the event;
b) based on the initial classification for the event, classifying the event using a neural network classifier, wherein classifying the event using the neural network classifier provides a neural network classification for the event;
c) based on the neural network classification for the event, classifying the event using a second explicit classifier, wherein classifying the event using the second explicit classifier provides an output classification for the event; and
d) processing the event based on the output classification for the event.

16. The computer readable medium of claim 15, wherein:
a) the method further comprises extracting a set of unstructured data items from a record related to the event; and
b) classifying the event using the neural network classifier comprises providing the set of unstructured data items to the neural network classifier as input.

17. The computer readable medium of claim 16, wherein:
a) the method further comprises, based on the initial classification for the event, obtaining an intermediate classification for the event; and
b) classifying the event using the neural network classifier comprises providing the intermediate classification for the event to the neural network as input.

18. The computer readable medium of claim 17, wherein:
a) the record relating to the event comprises a factual summary created in connection with the intermediate classification for the event; and
b) the instructions are operable to, when executed, extract the set of unstructured data items from the record relating to the event using a neural network other than the neural network classifier.

19. The computer readable medium of claim 17, wherein:
a) the method further comprises extracting a second set of unstructured data items from a second record related to the event; and
b) classifying the event using the neural network classifier comprises providing the second set of unstructured data items to the neural network as input.

20. The computer readable medium of claim 19, wherein the instructions are operable to, when executed, make the second record related to the event available a basis for the intermediate classification for the event and for the record related to the event from which the set of unstructured data items are extracted.
